(19) United States
(12) Patent Application Publication
(10) Pub. No.: US 2017/0073489 A1
(43) Pub. Date: Mar. 16, 2017

(54) FOAMING FILLER COMPOSITION HAVING HIGH RIGIDITY AND HIGH STRENGTH

(71) Applicant: HYUNDAI MOTOR COMPANY, Seoul (KR)

(72) Inventor: Hwan Oh KIM, Incheon (KR)

(21) Appl. No.: 14/956,254

(22) Filed: Dec. 1, 2015

(30) Foreign Application Priority Data
Sep. 10, 2015 (KR) 10-2015-0128227

(51) Int. Cl. C08J 9/00; C08J 9/10; C08J 9/14; C08J 9/32

(52) U.S. Cl. CPC C08J 9/0061; C08J 9/32; C08J 9/105; C08J 9/141; C08J 2363/10; C08J 2463/00

(57) ABSTRACT

A foaming filler composition having high rigidity and high strength comprises 20 to 30% by weight of a bisphenol A epoxy resin; 30 to 40% by weight of an acrylic rubber-modified epoxy resin; 3 to 5% by weight of glass bubbles having an average bubble diameter of 30 to 40 μm; 1.5 to 3% by weight of a blowing agent; 10 to 20% by weight of a chain extender comprising heavy calcium carbonate and light calcium carbonate; and 10 to 12% by weight of a dicyandiamide-based curing agent.

### CROSS-REFERENCE TO RELATED APPLICATION

This application claims priority under 35 U.S.C. §119(a) to Korean Patent Application No. 10-2015-0128227 filed on Sep. 10, 2015, the entire contents of which are incorporated herein by reference.

### TECHNICAL FIELD

The present disclosure relates to a foaming filler composition having high rigidity and high strength. More particularly, the present disclosure relates to a foaming filler composition having high rigidity and high strength, which is capable of reducing deformation of vehicle bodies and enhancing damage resistance of the vehicle bodies upon vehicle collision, and relieving impact while significantly improving a foaming ratio to increase a volume of the composition.

### BACKGROUND

To enhance rigidity of automotive bodies and improve impact performance, an ultra-high strength steel sheet has been used for the automotive bodies or for the use of structural adhesives. However, when the ultra-high strength steel sheets are applied to the automotive bodies, rigidity may be degraded due to a decrease in thickness, and it is difficult to enhance the strength.

Generally, a large number of cavities are present in a structure of an automotive body. For example, there is a gap between B-PLR outer and inner panels. Conventional structural adhesives have an effect of enhancing strength when they are applied to such a gap between the panels, but have a drawback in that a very large amount of the adhesives is used to fill the cavities, resulting in increase in vehicle weight and material cost.

Therefore, there exits a need for enhancing rigidity and strength of a steel sheet without increase in thickness of the steel sheet even when cavities of automotive bodies or various hollow parts are filled with a small amount of a foaming filler.

The above information disclosed in this Background section is only for enhancement of understanding of the background of the invention, and therefore, it may contain information that does not form the prior art that is already known to a person of ordinary skill in the art.

### SUMMARY OF THE DISCLOSURE

The present disclosure has been made in an effort to solve the above-described problems associated with the prior art.

To solve the above problems, a foaming filler composition has been prepared by mixing glass bubbles for impact absorption and physical and chemical blowing agents with a bisphenol A epoxy resin and an acrylic rubber-modified epoxy resin, and then foamed by heat curing to fill cavities in a panel. Thus, the foaming filler composition can reduce deformation of vehicle bodies and enhance damage resistance of the vehicle bodies upon vehicle collision without causing an increase in thickness of a steel sheet for the vehicle bodies. Further, the foaming filler composition can distribute stress upon collision to relieve impact while significantly improving a foaming ratio to increase a volume of the composition. An aspect of the present inventive concept provides a foaming filler composition having high rigidity and high strength capable of reducing deformation of vehicle bodies and enhancing damage resistance of the vehicle bodies.

Objects of the present inventive concept are not limited to the objects referred to above, however, will be clarified through descriptions below and will be realized by means disclosed in the appended claims and combinations thereof.

In order to achieve the objects, the present disclosure includes embodiments as follows.

According to an embodiment of the present inventive concept, a foaming filler composition having high rigidity and high strength includes 20 to 30% by weight of a bisphenol A epoxy resin, 30 to 40% by weight of an acrylic rubber-modified epoxy resin, 3 to 5% by weight of glass bubbles having an average bubble diameter of 30 to 40 μm, 1.5 to 3% by weight of a blowing agent, 10 to 20% by weight of a chain extender including heavy calcium carbonate and light calcium carbonate, and 10 to 12% by weight of a dicyandiamide-based curing agent.

Other aspects and embodiments of the invention are discussed infra.

### DETAILED DESCRIPTION

Hereinafter reference will be made in detail to various embodiments of the present inventive concept. While the invention will be described in conjunction with exemplary embodiments, it will be understood that the present description is not intended to limit the invention to the exemplary embodiments. On the contrary, the invention is intended to cover not only the exemplary embodiments, but also various alternatives, modifications, equivalents, and other embodiments, which may fall within the spirit and scope of the invention as defined by the appended claims.

In the description of the present disclosure, certain detailed explanations of the related art are omitted when it is deemed that they may unnecessarily obscure the essence of the invention. Throughout this specification, unless explicitly described otherwise, the expression “including” will be understood to imply the inclusion of stated elements but not the exclusion of any other elements.

Hereinafter, the present disclosure will be described in further detail with reference to exemplary embodiments.

The present disclosure provides a foaming filler composition having high rigidity and high strength, which includes 20 to 30% by weight of a bisphenol A epoxy resin, 30 to 40% by weight of an acrylic rubber-modified epoxy resin, 3 to 5% by weight of glass bubbles having an average bubble diameter of 30 to 40 μm, 1.5 to 3% by weight of a blowing agent, 10 to 20% by weight of a chain extender including heavy calcium carbonate and light calcium carbonate, and 10 to 12% by weight of a dicyandiamide-based curing agent.

According to an embodiment of the present inventive concept, the bisphenol A epoxy resin imparts shear strength to the foaming filler composition, and may be used in an amount of 20 to 30% by weight, based on the total weight of the composition. Specifically, the shear strength may be lowered when the content of the bisphenol A epoxy resin is less than 20% by weight, whereas collision resistance may be degraded when the content of the bisphenol A epoxy resin is greater than 30% by weight.

According to another embodiment of the present inventive concept, the acrylic rubber-modified epoxy resin imparts collision resistance, and may be used in an amount of 30 to 40% by weight, based on the total weight of the composition. Specifically, the collision resistance may be degraded when the content of the acrylic rubber-modified epoxy resin is less than 30% by weight, whereas shear strength may be lowered when the content of the acrylic rubber-modified epoxy resin is greater than 40% by weight.

According to still another embodiment of the present inventive concept, the glass bubbles enhance compressive strength and improve impact absorption as bubbles are burst upon collision. Here, the glass bubbles having an average bubble diameter of 30 to 40 μm may be used. Specifically, impact absorbance may be degraded when the average bubble diameter of the glass bubbles is less than 30 μm, whereas physical properties may be deteriorated due to particle crushing caused upon discharging when the average bubble diameter of the glass bubbles is greater than 40 μm. In a certain embodiment, the glass bubbles may have an average bubble diameter of 33 to 37 μm, or an average bubble diameter of 35 μm. In addition, the glass bubbles may be used in an amount of 3 to 5% by weight, based on the total weight of the composition. In this case, the impact absorbance may be degraded when the content of the glass bubbles is less than 3% by weight, whereas workability may be degraded when the content of the glass bubbles is greater than 5% by weight.

According to still another embodiment of the present inventive concept, the blowing agent may increase a volume of a filler composition and distribute stress upon collision by remarkably foaming the epoxy resin to 100 to 200% to fill a gap between panels. Such a blowing agent may include 1 to 2% by weight of a chemical blowing agent, and 0.5 to 1% by weight of a physical blowing agent. Specifically, a foaming ratio may be lowered due to a low gas generation rate when the content of the chemical blowing agent is less than 1% by weight, whereas physical properties may be degraded when the content of the chemical blowing agent is greater than 2% by weight. In addition, a bubble generation rate may be lowered due to heat of reaction when the content of the physical blowing agent is less than 0.5% by weight, whereas physical properties may be degraded when the content of the physical blowing agent is greater than 1% by weight. In the case of the blowing agent, when the chemical or physical blowing agent is used alone, shear strength and crashworthiness may be degraded upon foaming. Therefore, the chemical and physical blowing agents may be used together.

According to still another embodiment of the present inventive concept, the chemical blowing agent that may be used herein may include at least one selected from the group consisting of 4,4′-oxybis(benzenesulfonyl hydrazide) (OBSH), azodicarbonamide, and p-toluenesulfonyl hydrazide.

According to still another embodiment of the present inventive concept, the physical blowing agent that may be used herein may include at least one selected from the group consisting of cyclopentane, carbon dioxide, ethane, propane, n-butane, isobutane, n-pentane, isopentane, neopentane, ethanol, 1,1-difluoroethane (HFC-152a), 1,1,1,2-tetrafluoroethane (HFC-134a), 1,1,2,2-tetrafluoroethane (HFC-134), ethyl chloride, 1-chloro-1,1-difluoroethane (HCFC-142b), and chlorodifluoromethane (HCFC-22).

According to still another embodiment of the present inventive concept, the chain extender is an extender pigment which imparts workability such as dischargeability, flowability, etc., and may include 5 to 10% by weight of the heavy calcium carbonate and 5 to 10% by weight of the light calcium carbonate. Specifically, workability may be degraded when the content of the heavy calcium carbonate is less than 5% by weight, whereas shear strength may be lowered when the content of the heavy calcium carbonate is greater than 10% by weight. In addition, workability may be degraded when the content of the light calcium carbonate is less than 5% by weight, whereas physical properties such as crashworthiness may be degraded when the content of the light calcium carbonate is greater than 10% by weight.

According to still another embodiment of the present inventive concept, the heavy calcium carbonate and light calcium carbonate in the chain extender are calcite, and have different average particle sizes. That is, the heavy calcium carbonate may have an average particle size of 60 to 70 μm, and the light calcium carbonate may have an average particle size of 10 to 20 μm. Specifically, workability may be degraded when the average particle size of the heavy calcium carbonate is less than 60 μm, whereas physical properties such as shear strength may be degraded when the average particle size of the heavy calcium carbonate is greater than 70 μm. In addition, workability may be degraded when the average particle size of the light calcium carbonate is less than 10 μm, whereas physical properties such as shear strength may be degraded when the average particle size of the light calcium carbonate is greater than 20 μm. In the case of the chain extender, the physical properties and workability may be controlled by mixing heavy calcium carbonate having a higher average particle size with light calcium carbonate having a relatively lower particle size.

According to yet another embodiment of the present inventive concept, the dicyandiamide-based curing agent is used to cure a resin, and thus may be used in an amount of 10 to 12% by weight, based on the total weight of the composition. In this case, the resin may not be cured when the content of the dicyandiamide-based curing agent is less than 10% by weight, whereas the resin may remain as a residual substance, which may give out a foul odor, when the content of the dicyandiamide-based curing agent is greater than 12% by weight.

According to yet another embodiment of the present inventive concept, the filler composition may further include 3 to 5% by weight of an elasticizer, 3 to 5% by weight of a tackifier, 3 to 5% by weight of a water absorbing agent, and 1 to 2% by weight of a stabilizing agent. Specifically, the elasticizer imparts impact resilience, and calcium carbonate may be used as the elasticizer. In this case, impact resilience may be lowered when the content of the elasticizer is less than 3% by weight, whereas shear strength may be degraded when the content of the elasticizer is greater than 5% by weight.

In addition, the tackifier imparts adhesive strength to steel sheets, and a polyamide may be used as the tackifier. In this case, adhesive strength may be degraded when the content of the tackifier is less than 3% by weight, whereas crashworthiness may be degraded when the content of the tackifier is greater than 5% by weight.

In addition, the water absorbing agent imparts moisture resistance, and calcium oxide (CaO) may be used as the water absorbing agent. In this case, swelling caused by moisture may occur when the content of the water absorbing agent is less than 3% by weight, whereas adhesive strength may be degraded when the content of the water absorbing agent is greater than 5% by weight.

Additionally, the stabilizing agent imparts thermal stability, and tin oxide (SnO₂) may be used as the stabilizing agent. In this case, thermal resistance may be degraded when the content of the stabilizing agent is less than 1% by weight, whereas adhesive strength may be lowered when the content of the stabilizing agent is greater than 2% by weight.

Therefore, the foaming filler composition according to one exemplary embodiment of the present inventive concept can be useful in reducing deformation of vehicle bodies and enhancing damage resistance of the vehicle bodies upon vehicle collision without causing an increase in thickness of a steel sheet for the vehicle bodies when the foaming filler composition is prepared by mixing glass bubbles for impact absorption, a chain extender, and an elasticizer with a bisphenol A epoxy resin and an acrylic rubber-modified epoxy resin, and then foamed by heat curing to fill cavities in a panel.

In addition, the foaming filler composition according to the exemplary embodiment of the present inventive concept can be useful in significantly improving a foaming ratio (100 to 200%) to increase a volume of the composition, and distributing stress upon collision to relieve impact when the physical and chemical blowing agents are mixed for use.

Therefore, the foaming filler composition can be applied to various parts having cavities formed therein, parts required to enhance rigidity and strength, or parts requiring watertightness, as well as the automotive bodies.

Hereinafter, one or more embodiments of the present inventive concept will be described in detail with reference to the following examples. However, these examples are not intended to limit the purpose and scope of the one or more embodiments.

### EXAMPLES

The following examples illustrate the invention and are not intended to limit the same.

### Examples 1 and 2 and Comparative Examples 1 and 2

Foaming filler compositions were prepared using the components and their content ratios as listed in the following Table 1.

TABLE 1

| | | | | Comparative | |
|---|---|---|---|---|---|
| | | Examples | | Examples | |
| Components | | 1 | 2 | 1 | 2 |
| Resins | Bisphenol A epoxy | 22.7 | 21.5 | 27.7 | 26.1 |
| | Acrylic rubber-modified | 33.5 | 35.7 | 28.5 | 31.3 |
| | epoxy | | | | |
| Curing agent | Dicyanamide | 10.0 | 10.5 | 10.2 | 11.2 |
| Elasticizer | Calcium carbonate | 4.2 | 3.7 | 4.2 | 4.5 |
| Tackifier | Polyamide | 3.3 | 3.0 | 3.3 | 3.4 |
| Chain | Heavy calcium carbonate | 7.6 | 7.8 | 9.1 | 7.4 |
| extender | (rough stone: calcite; average | | | | |
| | particle size: 60 to 70 μm) | | | | |
| | Light calcium carbonate | 8.0 | 6.5 | 9.7 | 8.6 |
| | (rough stone: calcite; average | | | | |
| | particle size: 10 to 20 μm) | | | | |
| Impact | Glass bubbles (average | 3.2 | 4.1 | — | 2.3 |
| absorber | bubble size: 35 μm) | | | | |
| Blowing | Chemical blowing agent: | 1.3 | 1.2 | 2.0 | 1.7 |
| agent | OBSH | | | | |
| | Physical blowing agent: | 0.9 | 0.6 | — | 0.5 |
| | cyclopentane | | | | |
| Water | Calcium oxide (CaO) | 4.0 | 4.2 | 4.0 | 2.0 |
| absorbing | | | | | |
| agent | | | | | |
| Stabilizing | Tin oxide (SnO₂) | 1.3 | 1.2 | 1.3 | 1.0 |
| agent | | | | | |

| | | | | |
|---|---|---|---|---|
| Total | 100.0 | 100.0 | 100.0 | 100.0 |

### TEST EXAMPLES

### Test Example 1

Test specimens for drop evaluation with a size of 170×60×500 mm (steel coil: SPRC440, and spot-welded at 10 points) were used to measure physical properties of the foaming filler compositions prepared in Examples 1 and 2 and Comparative Examples 1 and 2. In this case, a drop tower test was performed under the following conditions. Results are listed in Table 2.

[Drop Evaluation Conditions for Drop Tower Test]

Drop height: 200 mm

Drop weight: 400 kgf

Drop velocity: 1.98 m/s

TABLE 2

| | | | Evaluation results | | | |
|---|---|---|---|---|---|---|
| Main | | | | | Comparative | |
| evaluation | | Require- | Examples | | Examples | |
| items | | ments | 1 | 2 | 1 | 2 |
| Material | appear- | Swelled, | Good | Good | Good | Swelled |
| proper- | ance | not | | | | |
| ties | | cracked | | | | |
| | Foaming | 100-200% | 185% | 175% | 175% | 160% |
| | ratio | | | | | |
| | Shear | 10 MPa or | 16.0 | 14.1 | 8.9 | 10.1 |
| | strength | more (CF | | | | |
| | | 70% ↑) | | | | |
| | Impact | Impact en- | 9.3 | 11.5 | 4.2 | 4.6 |
| | perfor- | ergy level: | | | | |
| | mance | 5N/mm or | | | | |
| | | more | | | | |
| | Flexural | 8 kgf or | 9.3 | 10.2 | 5.6 | 7.5 |
| | rigidity | more | | | | |
| | Water- | Not leaked | Good | Good | Good | Good |
| | tightness | | | | | |
| Simpli- | Collision | Decreased | 40.1% | 50.4% | 13.9% | 30.0% |
| fied drop | deforma- | by 15% | (68 mm) | (57 mm) | (99 mm) | (81 mm) |
| evalu- | tion | or more vs. | | | | |
| ation | (mm) | uncoated | | | | |
| | | (115 mm | | | | |
| | | when | | | | |
| | | uncoated) | | | | |
| | Energy | Decreased | 34.4% | 50.4% | 6.9% | 20.7% |
| | absorp- | by 20% or | (0.39 kJ) | (0.42 kJ) | (0.31 kJ) | (0.35 kJ) |
| | tion (kJ) | more vs. | | | | |
| | | uncoated | | | | |
| | | (0.29 kJ | | | | |
| | | when | | | | |
| | | uncoated) | | | | |

Test specimens for simplified drop evaluation: outer plate/REINF/inner plate (0.8 t/1.0 t/1.2 t), based on a gap of 5 mm

Based on the results listed in Table 2, it could be seen that the foaming filler compositions of Examples 1 and 2 in which the acrylic rubber-modified epoxy, the glass bubbles, and the blowing agent were added in proper amounts had satisfactory physical requirements such as shear strength, crashworthiness, and flexural rigidity, collision deformation significantly decreased by approximately 40 to 50% in simplified drop evaluation, and energy absorption significantly increased by 30 to 50%, compared to the case where the test specimens were not coated.

In addition, it could be seen that an outer plate, REINF and an inner plate had a weight of 1.0 t, 1.2 t and 1.2 t in the case of conventional test specimens for drop evaluation, but had a weight of 0.8 t, 1.0 t and 1.2 t in the case of the test specimens used in Test Example 1, indicating that the thicknesses of the steel sheets decreased by approximately 4 to 8%.

On the other hand, it could be seen that the foaming filler composition of Comparative Example 1 in which the acrylic rubber-modified epoxy was added in a small amount, and the glass bubbles and the physical blowing agent were not added had inferior impact absorption to the foaming filler compositions of Examples 1 and 2, and thus did not easily express reinforcing performance upon collision. In addition, it could be seen that, when the chemical blowing agent was used alone, shear strength and impact performance were degraded upon foaming, indicating that the foaming filler composition of Comparative Example 1 did not satisfy desired physical requirements.

Further, it was revealed that the foaming filler composition of Comparative Example 2 in which the glass bubbles and the water absorbing agent were added in small amounts particularly had remarkably degraded crashworthiness and flexural rigidity, and swelling occurred due to the lack in content of the water absorbing agent, indicating that the test specimens of Comparative Example 2 had poor durability when the composition was applied to the test specimens.

Based on these results, it was confirmed that the foaming filler compositions prepared in Examples 1 and 2 had effects of reducing deformation of vehicle bodies and enhancing damage resistance of the vehicle bodies upon vehicle collision without increasing the thickness of a steel sheet for vehicle bodies when the foaming filler composition is prepared by mixing the glass bubbles for impact absorption, the chain extender, and the elasticizer with the bisphenol A epoxy resin and the acrylic rubber-modified epoxy resin, and then foamed by heat curing to fill cavities in a panel.

In addition, it was confirmed that the foaming filler compositions of Examples 1 and 2 had effects of significantly improving a foaming ratio to increase a volume of the composition and distributing stress upon collision to relieve impacts when the physical and chemical blowing agents were mixed.

The foaming filler composition having high rigidity and high strength according to one exemplary embodiment of the present inventive concept can have effects of reducing deformation of car bodies and enhancing damage resistance of the car bodies upon vehicle collision without causing an increase in thickness of a steel sheet for vehicle bodies when the foaming filler composition is prepared by mixing the glass bubbles for impact absorption, the chain extender, and the elasticizer with the bisphenol A epoxy resin and the acrylic rubber-modified epoxy resin, and then foamed by heat curing to fill cavities in a panel.

In addition, the foaming filler composition according to one exemplary embodiment of the present inventive concept can have effects of significantly improving a foaming ratio to increase a volume of the composition and distributing stress upon collision to relieve impact when the physical and chemical blowing agents were mixed.

Therefore, the foaming filler composition according to one exemplary embodiment of the present inventive concept can be applied to various parts having cavities formed therein, parts requiring enhanced rigidity and strength, or parts requiring watertightness, as well as the automotive bodies.

The invention has been described in detail with reference to embodiments thereof. However, it will be appreciated by those skilled in the art that changes may be made in these embodiments without departing from the principles and spirit of the invention, the scope of which is defined in the appended claims and their equivalents.

What is claimed is:

1. A foaming filler composition having high rigidity and high strength, the composition comprising:
20 to 30% by weight of a bisphenol A epoxy resin;
30 to 40% by weight of an acrylic rubber-modified epoxy resin;
3 to 5% by weight of glass bubbles having an average bubble diameter of 30 to 40 μm;
1.5 to 3% by weight of a blowing agent;
10 to 20% by weight of a chain extender comprising heavy calcium carbonate and light calcium carbonate; and
10 to 12% by weight of a dicyandiamide-based curing agent.

2. The foaming filler composition according to claim 1, wherein the blowing agent comprises 1 to 2% by weight of a chemical blowing agent, and 0.5 to 1% by weight of a physical blowing agent.

3. The foaming filler composition according to claim 2, wherein the chemical blowing agent comprises at least one selected from the group consisting of 4,4′-oxybis(benzenesulfonyl hydrazide), azodicarbonamide, and p-toluenesulfonyl hydrazide.

4. The foaming filler composition according to claim 2, wherein the physical blowing agent comprises at least one selected from the group consisting of cyclopentane, carbon dioxide, ethane, propane, n-butane, isobutane, n-pentane, isopentane, neopentane, ethanol, 1,1-difluoroethane (HFC-152a), 1,1,1,2-tetrafluoroethane (HFC-134a), 1,1,2,2-tetrafluoroethane (HFC-134), ethyl chloride, 1-chloro-1,1-difluoroethane (HCFC-142b), and chlorodifluoromethane (HCFC-22).

5. The foaming filler composition according to claim 1, wherein the chain extender comprises 5 to 10% by weight of the heavy calcium carbonate and 5 to 10% by weight of the light calcium carbonate.

6. The foaming filler composition according to claim 1, wherein, in the chain extender, the heavy calcium carbonate has an average particle size of 60 to 70 μm and the light calcium carbonate has an average particle size of 10 to 20 μm.

7. The foaming filler composition according to claim 1, further comprising 3 to 5% by weight of an elasticizer, 3 to 5% by weight of a tackifier, 3 to 5% by weight of a water absorbing agent, and 1 to 2% by weight of a stabilizing agent, based on the total weight of the filler composition.

8. The foaming filler composition according to claim 7, wherein the elasticizer is calcium carbonate, the tackifier is polyamide, the water absorbing agent is calcium oxide (CaO), and the stabilizing agent is tin oxide (SnO₂).
